(19) United States
(12) Patent Application Publication
(10) Pub. No.: US 2012/0113470 A1
(43) Pub. Date: May 10, 2012

(54) INFORMATION PROCESSING APPARATUS, IMAGE FORMATION APPARATUS, AND RECORDING MEDIUM RECORDED WITH CONTROL PROGRAM FOR INFORMATION PROCESSING APPARATUS

(75) Inventors: Tomoyuki Atsumi, Toyohashi-shi (JP); Takuya Okada, Toyokawa-shi (JP); Katsuaki Wakui, Toyokawa-shi (JP); Yuji Kawamura, Hachioji-shi (JP)

(73) Assignee: Konica Minolta Business Technologies, Inc., Chiyoda-ku (JP)

(21) Appl. No.: 13/291,371

(22) Filed: Nov. 8, 2011

(30) Foreign Application Priority Data
Nov. 10, 2010 (JP) 2010-251867

(51) Int. Cl. G06F 15/00

(52) U.S. Cl. 358/1.15

(57) ABSTRACT

When an input of a setting execution instruction of test printing at the setting screen is accepted, a setting screen of finalized printing differing from the test printing is displayed at the display. When an input of a setting execution instruction at the setting screen of finalized printing is accepted, a first print job including first print data that is a version of image data converted based on an input of a setting execution instruction of test printing is generated. The generated first print job is transmitted to an image formation apparatus through a transmitter. After the first print job is transmitted, a second print job including second print data that is a version of image data converted based on an input of a setting execution instruction of finalized printing is generated.

This application is based on Japanese Patent Application No. 2010-251867 filed with the Japan Patent Office on Nov. 10, 2010, the entire content of which is hereby incorporated by reference.

### BACKGROUND OF THE INVENTION

1. Field of the Invention

The present invention relates to printing technique for printing image data produced through application software (word processing software and the like) operating on a computer.

2. Description of the Related Art

In a conventional print system, printing of data (a data file produced through an application) stored in a secondary storage device or the like of a computer was executed by a user according to the following procedures.

The case where Windows (registered trademark), for example, is employed as the basic software (Operating System) of a computer will be described. On this basic software, data that is the subject of printing is stored in the form of “file data”.

The user retrieves the file data that is the subject of printing and executes the application by which that file data has been produced (for example, the word processing software, spread sheet software or the like that is a text editing application) to open the file data that is the subject of printing.

When the printing process on the image data that has been opened and displayed is executed, the text editing application invokes the printer driver through an intermediate module (GDI (Graphical Device Interface)) under control of the OS on the computer. The invoked printer driver generates PDL (Page Description Language) that can be interpreted by the controller of the image formation apparatus that will carry out printing and transmits the generated PDL to the image formation apparatus as a print job.

In the case where the file data that is the subject of printing includes image data of many pages, the user may request execution of various test printing such as instructing the printing of only pages required to be confirmed in order to avoid printing mistakes, reducing the number of copies to be printed, executing aggregate printing, enlargement printing, or printing in black and white to reduce the cost.

In this context, various schemes have been proposed conventionally. For example, Japanese Laid-Open Patent Publication No. 2001-334707 discloses the method of, in the execution of finalized printing that is the real and main printing after test printing, reducing the time required for executing finalized printing by using the print data of test printing.

However, the conventional method requires cumbersome operation. When the test printing carried out by the image formation apparatus was confirmed and satisfactory, the computer had to be operated again to instruct execution of finalized printing.

### SUMMARY OF THE INVENTION

In view of the foregoing, an object of the present invention is to provide an information processing apparatus allowing execution of test printing and finalized printing readily without the execution of cumbersome operation, an image formation apparatus, and a recording medium recorded with a control program for the information processing apparatus.

According to an aspect of the present invention, an information processing apparatus transmitting image data produced through application software to an image formation apparatus for printing includes a display capable of displaying a setting screen directed to printing image data, a transmitter transmitting data to the image formation apparatus, and a controller controlling the information processing apparatus totally. The controller is configured to determine whether an input of a setting execution instruction of test printing at the setting screen of image data displayed on the display is accepted; display a setting screen directed to finalized printing differing from the test printing when an input of a setting execution instruction of test printing at the setting screen is accepted; determine whether an input of a setting execution instruction at the setting screen directed to finalized printing is accepted; generate a first print job directed to executing test printing of the image data when an input of a setting execution instruction at the setting screen directed to finalized printing is accepted. The first print job includes first print data that is a version of the image data converted based on an input of the setting execution instruction of test printing. The controller is further configured to transmit the generated first print job to the image formation apparatus via the transmitter; generate a second print job directed to executing finalized printing of the image data, after the first print job is transmitted. The second print job includes second print data that is a version of image data converted based on an input of the setting execution instruction of finalized printing. The controller is further configured to transmit the generated second print job to the image formation apparatus via the transmitter.

Preferably, the controller is configured to issue identification information corresponding to the image data when an input of a setting execution instruction of test printing at the setting screen is accepted; and generate a first print job including the first print data and the identification information when an input of a setting execution instruction at the setting screen directed to finalized printing is accepted.

Particularly, the controller is configured to generate a second print job including the second print data and the identification information after the first print job is transmitted.

Preferably, the controller is configured to accept an input of specified page data in test printing of image data constituted of multiple page data at the setting screen.

Preferably, the image formation apparatus further includes a memory. The controller is configured to determine whether an input of a modifying instruction of setting contents at the setting screen directed to finalized printing is accepted; update and display the setting screen directed to finalized printing when an input of a modifying instruction of the setting screen directed to finalized printing is accepted; determine whether an input of an instruction to store setting information indicating the setting contents at the setting screen directed to finalized printing is accepted; and store setting information that can be used for the setting contents at the setting screen directed to finalized printing in the memory, when an input of an instruction to store at the setting screen directed to finalized printing is accepted.

Particularly, the controller is configured to compare the setting information indicating setting contents at the setting screen directed to finalized printing with the setting information stored in the memory, based on an input of a setting execution instruction of finalized printing; and display a confirmation screen of the setting contents on the display when the setting information differ from each other based on the comparison.

Particularly, the controller is configured to store, in the memory, setting information indicating setting contents at the setting screen directed to finalized printing corresponding to the identification information identifying image data when an input of an instruction to store at the setting screen directed to finalized printing is accepted, and store, in the memory, another setting information associated with the identification information according to update of the setting contents at the setting screen directed to finalized printing, when an input of an instruction to store at the setting screen directed to finalized printing is accepted a plurality of times.

Particularly, the controller is configured to determine whether an input of an instruction to read out the setting information stored in the memory, appearing at the setting screen directed to finalized printing, is accepted; and display on the display a select screen allowing selection of one of a plurality of setting information associated with the identification information stored in the memory.

According to an aspect of the present invention, an image formation apparatus printing out image data produced through application software of an information processing apparatus includes a receiver receiving first print data directed to executing test printing of image data transmitted from the information processing apparatus and second print data directed to executing finalized printing of image data transmitted together with the first print data, a printer executing an image formation process, a memory, and a controller controlling the image formation apparatus totally. The controller is configured to determine whether the first print data is received or not through the receiver; output the first print data to the printer for executing the image formation process when the first print data is received; determine whether the second print data is received through the receiver, and store the second print data in the memory when the second print data is received.

Preferably, the first and second print data include identification information associated with image data. The controller is configured to determine, when the first print data is received, whether the identification information included in the first print data is identical to the identification information included in the second print data stored in the memory; and erase the second print data including the same identification information stored in the memory, when a determination of being identical is made.

Preferably, the first and second print data include identification information associated with image data. The image formation apparatus further includes a display. The controller is configured to determine, after the image formation process of the first print data ends, whether there is second print data including identification information identical to the identification information of the first print data in the memory; and display a screen prompting execution of an image formation process of the second print data on the display when there is second print data including identification information identical to the identification information of the first print data.

Preferably, the first and second print data include user identification information identifying a user who wishes to print out image data. The image formation apparatus further includes a display. The controller is configured to display, on the display, an authentication screen allowing input of authentication information including user identification information for allowing the image formation apparatus to be operated; determine whether an input of authentication information at the authentication screen is accepted; execute an authentication process when there is an input of authentication information; when the authentication process succeeds, determine whether there is second print data including user identification information included in the authentication information; and display, on the display, a screen prompting execution of an image formation process of the second print data when there is second print data including user identification information.

An aspect of the present invention is directed to a recording medium recorded with a control program used at an information processing apparatus transmitting image data produced through application software to an image formation apparatus for printing, including a computer accepting an input of an instruction to the information processing apparatus via an input device, and controlling a display capable of displaying file data as an image, and a transmitter transmitting data to the image formation apparatus. The control program causes the computer to execute a process including the steps of: determining whether an input of a setting execution instruction of test printing at a setting screen of image data displayed on the display is accepted, based on an input through the input device; displaying on the display, a setting screen directed to finalized printing differing from the test printing when an input of a setting execution instruction of test printing at the setting screen is accepted; determining whether an input of a setting execution instruction at the setting screen directed to finalized printing is accepted, based on an input through the input device; generating a first print job directed to executing test printing of the image data when an input of a setting execution instruction at the setting screen directed to finalized printing is accepted. The first print job includes first print data that is a version of the image data converted based on an input of the setting execution instruction of test printing. The control program causes the computer to execute a process further including the steps of: transmitting the generated first print job to the image formation apparatus via the transmitter; and generating a second print job directed to executing finalized printing of the image data, after the first print job is transmitted. The second print job includes second print data that is a version of image data converted based on an input of a setting execution instruction of finalized printing. The control program causes the computer to execute a process further including the step of: transmitting the generated second print data to the image formation apparatus via the transmitter.

Preferably, the control program causes the computer to execute a process further including the step of accepting an input of specified page data in test printing of the image data constituted of multiple page data at the setting screen.

Preferably, the control program causes the computer to execute a process further including the step of issuing identification information corresponding to image data when an input of a setting execution instruction of test printing at the setting screen is accepted. In the step of generating a first print job, a first print job including first print data and identification information is generated.

Particularly, in the step of generating a second print job, a second print job including second print data and identification information is generated.

Preferably, the computer is further capable of controlling the memory. The control program causes the computer to execute a process including the steps of determining whether an input of a modifying instruction of setting contents at the setting screen directed to finalized printing is accepted; updating and displaying the setting screen directed to finalized printing on the display when an input of a modifying instruction at the setting screen directed to finalized printing is accepted; determining whether an input of an instruction to store setting information indicating setting contents is accepted at the setting screen directed to finalized printing; and storing setting information that can be used for the setting contents at the setting screen directed to finalized printing in the memory, when an input of an instruction to store is accepted at the setting screen directed to finalized printing.

Particularly, the control program causes the computer to execute a process further including the step of comparing setting information indicating the setting contents at the setting screen directed to finalized printing with the setting information stored in the memory, based on an input of a setting execution instruction of finalized printing; and displaying a confirmation screen of the setting contents on the display when the setting information differ from each other based on the comparison.

Particularly, the control program causes the computer to execute a process further including the steps of: storing, in the memory, setting information indicating setting contents at the setting screen directed to finalized printing associated with identification information identifying image data, when an input of an instruction to store at the setting screen directed to finalized printing is accepted; and storing in the memory another setting information associated with the identification information according to update of the setting contents at the setting screen directed to finalized printing, when an input of an instruction to store at the setting screen directed to finalized printing is accepted a plurality of times.

Particularly, the control program causes the computer to execute a process further including the steps of: determining whether an input of an instruction to read out setting information stored in the memory, appearing at the setting screen directed to finalized printing, is accepted; and displaying on the display a select screen allowing selection of one of a plurality of setting information associated with the identification information stored in the memory, when an input of an instruction to read out appearing at the setting screen directed to finalized printing is accepted.

According to an aspect of the present invention, an information processing apparatus generates a first print job including first print data that is a version of image data converted based on an input of a setting execution instruction of test printing, for executing test printing of image data; transmitting the generated first print job to an image formation apparatus via a transmitter; generating a second print job including second print data that is a version of image data converted based on an input of a setting execution instruction of finalized printing, for executing finalized printing of image data, after the first print job is transmitted; and transmitting the generated second print job to the image formation apparatus via the transmitter.

The image formation apparatus receives first and second print job related to test printing and finalized printing, respectively, and does not have to transmit the second print job related to finalized printing again from the information processing apparatus, after test printing to execute a print job. Thus, test printing and finalized printing can be executed conveniently without the execution of cumbersome operation.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 represents a configuration of an image formation system 1 according to a first embodiment of the present invention.

FIG. 2 represents a configuration of an MFP 10 according to the first embodiment.

FIG. 3 represents a configuration of a PC according to the first embodiment.

FIG. 4 is a flowchart of a print setting process of a PC 100 according to the first embodiment.

FIG. 5 represents an example of a print dialog screen 30 of an application according to the first embodiment.

FIG. 6 represents a print setting screen according to the first embodiment.

FIG. 7 is a flowchart of a subroutine of a test printing setting process according to the first embodiment.

FIG. 8 represents an identification table according to the first embodiment.

FIG. 9 represents a finalized printing confirmation screen according to the first embodiment.

FIG. 10 is a flowchart of a finalized printing setting process according to the first embodiment.

FIG. 11 represents a finalized printing setting screen according to the first embodiment.

FIG. 12 represents a print setting item select screen according to the first embodiment.

FIG. 13 is a flowchart of a print setting confirmation process according to the first embodiment.

FIG. 14 represents a finalized printing mismatch warning screen according to the first embodiment.

FIG. 15 represents a finalized printing update confirmation screen according to the first embodiment.

FIG. 16 is a flowchart of a print execution process according to the first embodiment.

FIG. 17 is a flowchart to describe the flow of reception at MFP 10 according to the first embodiment.

FIG. 18 is a flowchart of a reception process according to the first embodiment.

FIG. 19 is a flowchart of a finalized printing job confirmation process according to the first embodiment.

FIG. 20 represents a print job list according to the first embodiment.

FIG. 21 is a flowchart to describe the flow of a print process at MFP 10 according to the first embodiment.

FIG. 22 represents an operation panel 19 according to the first embodiment.

FIG. 23 represents a print setting screen according to a second embodiment of the present invention.

FIG. 24 is a flowchart to describe the flow of a print process at MFP 10 according to the second embodiment.

FIG. 25 is a flowchart to describe the flow of a finalized printing process at MFP 10 according to the second embodiment.

FIG. 26 represents a log-in screen displayed on the operation panel according to the second embodiment.

FIG. 27 represents an authentication table registered at MFP 10 according to the second embodiment.

FIG. 28 represents a finalized printing job select screen according to the second embodiment.

### DESCRIPTION OF THE PREFERRED EMBODIMENTS

Embodiments of the present invention will be described hereinafter with reference to the drawings. In the following description, the same elements and constituent elements have the same reference character allotted. The designation and function are also the same.

### First Embodiment

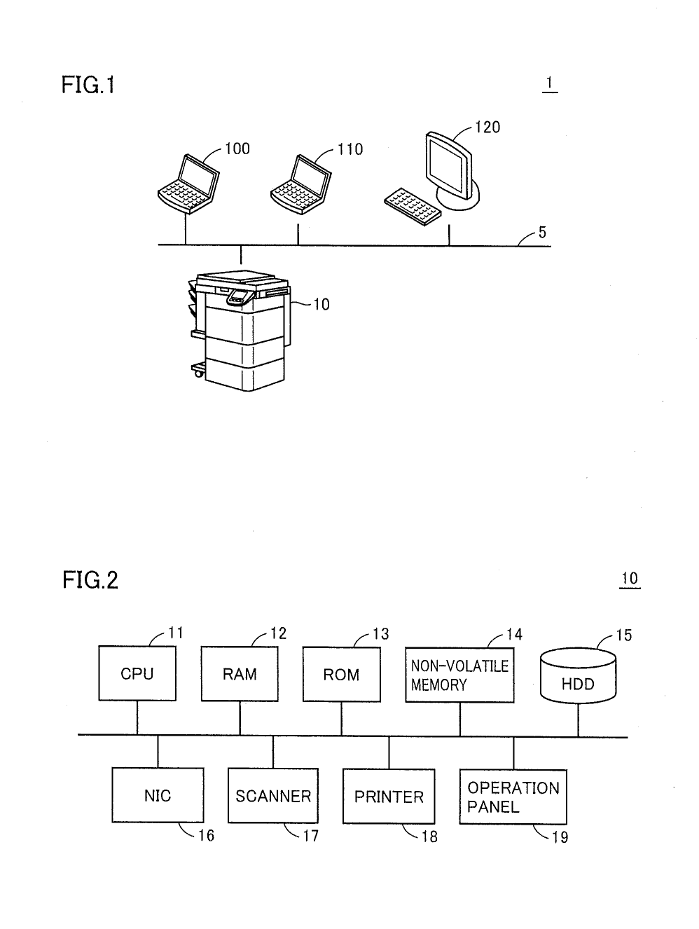

Referring to FIG. 1, an image formation system 1 according to a first embodiment of the present invention includes an MFP (Multi Function Peripheral) 10 that is an image formation apparatus, and external personal computers (PC) 100, 110 and 120 that are external terminals. MFP 10 and external PCs 100, 110 and 120 are connected to each other on a network, allowing data communication with each other. The present example will be described based on a configuration in which three external PCs and one MFP are connected on a local area network (LAN) 5. The number thereof is not limited to 1, and may include two or more. The first embodiment of the present invention can be implemented even by one external PC and one MFP. The network connection is not limited to a LAN, and may be a wide area network (WAN) or the like. Moreover, the connection may be wired, or wireless.

Referring to FIG. 2, MFP 10 according to the first embodiment of the present invention includes a central processing unit (CPU) 11 that is the control means for executing various programs including an operation system (OS), a random access memory (RAM) 12 for temporarily storing data required for execution of the program section of CPU 11, a hard disk drive 15 (HDD) and a non-volatile memory 14 that are storage means for storing in a non-volatile manner the program and data executed at CPU 11, a read-only memory (ROM) 13 having a program that will he executed at CPU 11 stored in advance, an operation panel 19 for the execution of various instructions, a scanner 17 for scanning an original to obtain image data, a printer 18 that is printing means for printing image data on a sheet medium, and a network interface card (NIC) 16 constituted of an LAN card or the like that is the transmission/reception means for executing data communication with an external source. It is assumed that operation panel 19 includes a display (display means), a key input unit, and the like. The elements are connected to each other through an internal bus, allowing the transmission/reception of data therebetween.

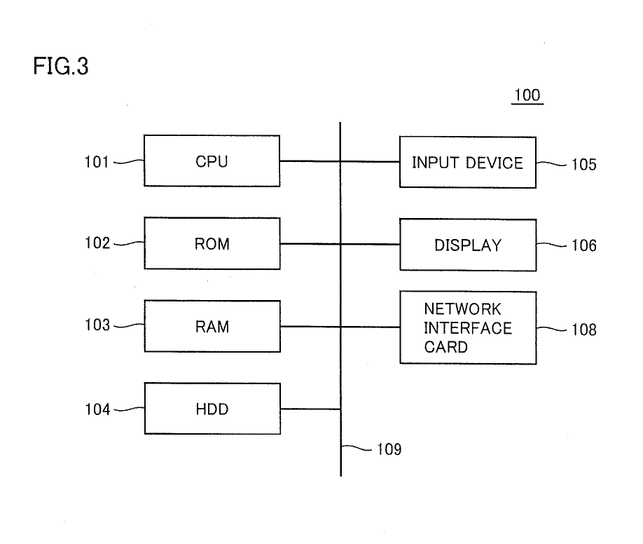

Referring to FIG. 3, PC 100 according to the first embodiment of the present invention includes a central processing unit (CPU) 101 that is a controller (control means) for executing various programs including an operating system, a RAM 103 temporarily storing data required for execution of the program section of CPU 101, a hard disk drive (HDD) 104 that is a memory (storage means) for storing, in a non-volatile manner, a program executed at CPU 101, various data, file, and the like, a ROM 102 having a program that will be executed by CPU 101 stored in advance, an input device (input means) 105 including a keyboard, mouse, or the like, a display 106, that is a display device (display means) for displaying a screen, and a network interface (NIC) 108 that is the transmitter/receiver (transmission/reception means) for executing transmission and reception of data with an external source via LAN 5.

Each of the elements set forth above receives and transmits data therebetween via an internal bus 109. PCUs 110 and 120 have a similar configuration. Therefore, description thereof will not be repeated. Although the present example has been described based on the case where display 106 is formed integrally with the PC unit, the present invention is not limited thereto, and a display 106 provided separate from the PC unit may be implemented.

ROM 102 or HDD 104 has the basic software (OS) of a computer and an application (for example, word processing software, spread sheet software that is a text editing application) operating on the relevant basic software stored. Data produced through the relevant application and that is the subject of printing is stored in the form of file data. At ROM 102 or HDD 104, a printer driver is stored for converting data that is the subject of printing into PDL (Page Description Language) for transmission as a print job.

The present example will be described based on the case where file data that is the subject of printing is opened, and a printing instruction is sent to MFP 10 related to the opened and displayed image data.

PC 100 has an IP address that is set in advance at MFP 10. PC 100 can transmit data that is the subject of printing to MFP 10 through the printer driver as a print job instructing execution of a print process.

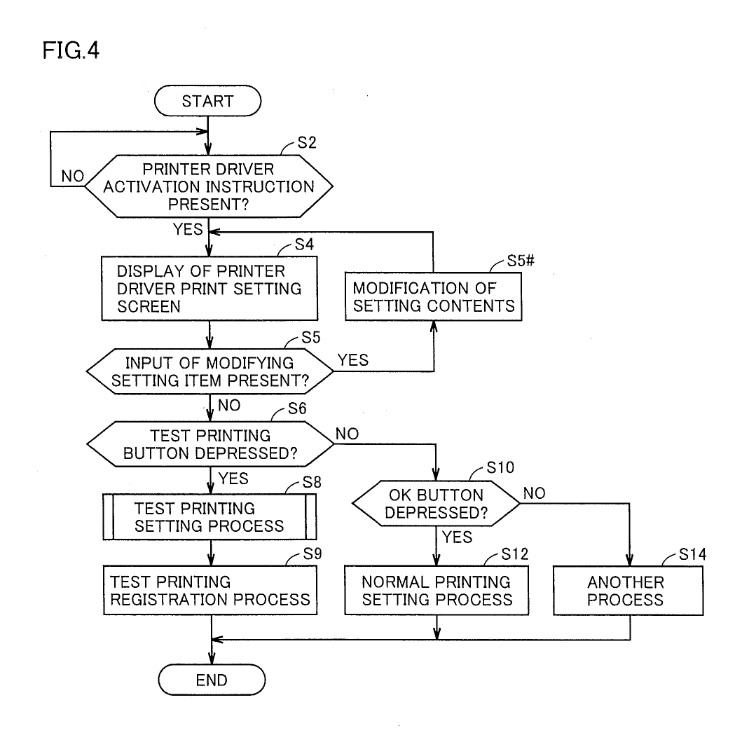

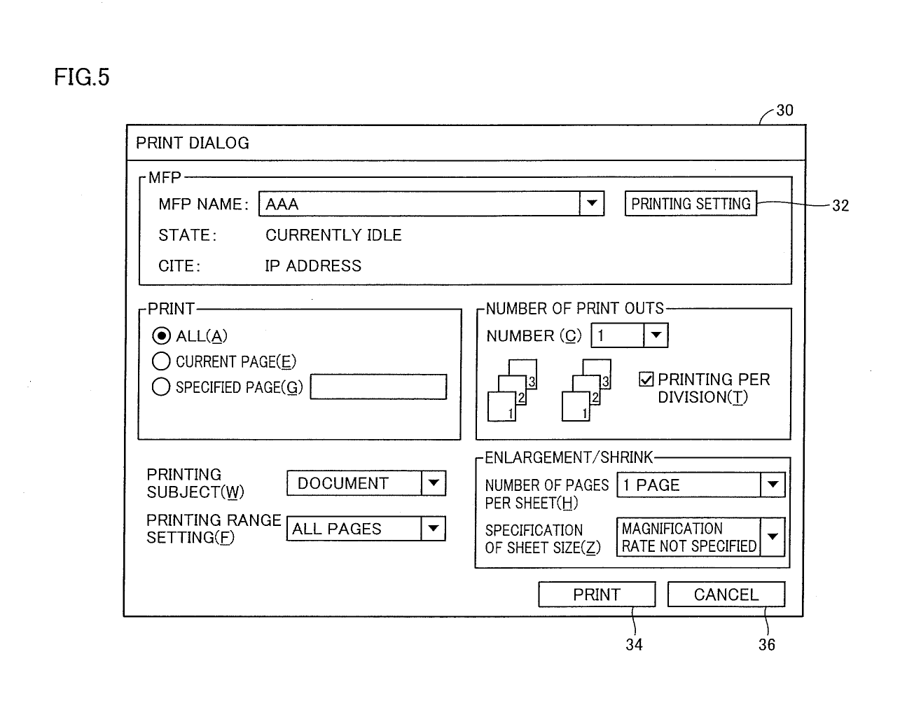

FIG. 4 is a flowchart of a print setting process at PC 100 according to the first embodiment. Here, the process of mainly CPU 101 will be described.

Referring to FIG. 4, CPU 101 determines whether there is an instruction to activate the printer driver (step S2). Although not shown, activation may be effected by opening the file data that is the subject of printing, displayed at display 106 of PC 100, and instructing through input device 105 an execution of the printing setting from a print dialog screen of the application corresponding to the opened file data.

FIG. 5 represents an example of a print dialog screen 30 of an application according to the first embodiment.

Referring to FIG. 5, specifically, at print dialog screen 30, selection of the printing device as well as the setting of various types of items such as the printing range, number of print outs, or the like is allowed. A “print setting” button 32 is provided. The printer driver is activated according to “print setting” button 32. In the present example, it is assumed that a designation AAA of MFP 10 and an IP address indicating its location are indicated.

A page specify input column is provided for the printing range. The user can specify the number of pages to be printed out through a mouse that is a pointing device, the keyboard, or the like.

At print dialog screen 30, a “print” button 34, and a “cancel” button 36 are provided. “Print” button 34 functions to instruct execution of printing the file data that is the subject of printing according to an application. “Cancel” button 36 functions to instruct termination of print dialog screen 30.

Returning to the flowchart of FIG. 4, when there is a printer driver activation instruction at step S2 (YES at step S2), CPU 101 causes display 106 to provide a print setting screen (step S4). Specifically, a print setting screen according to the printer driver is displayed in response to the selection of “print setting” button 32 on print dialog screen 30.

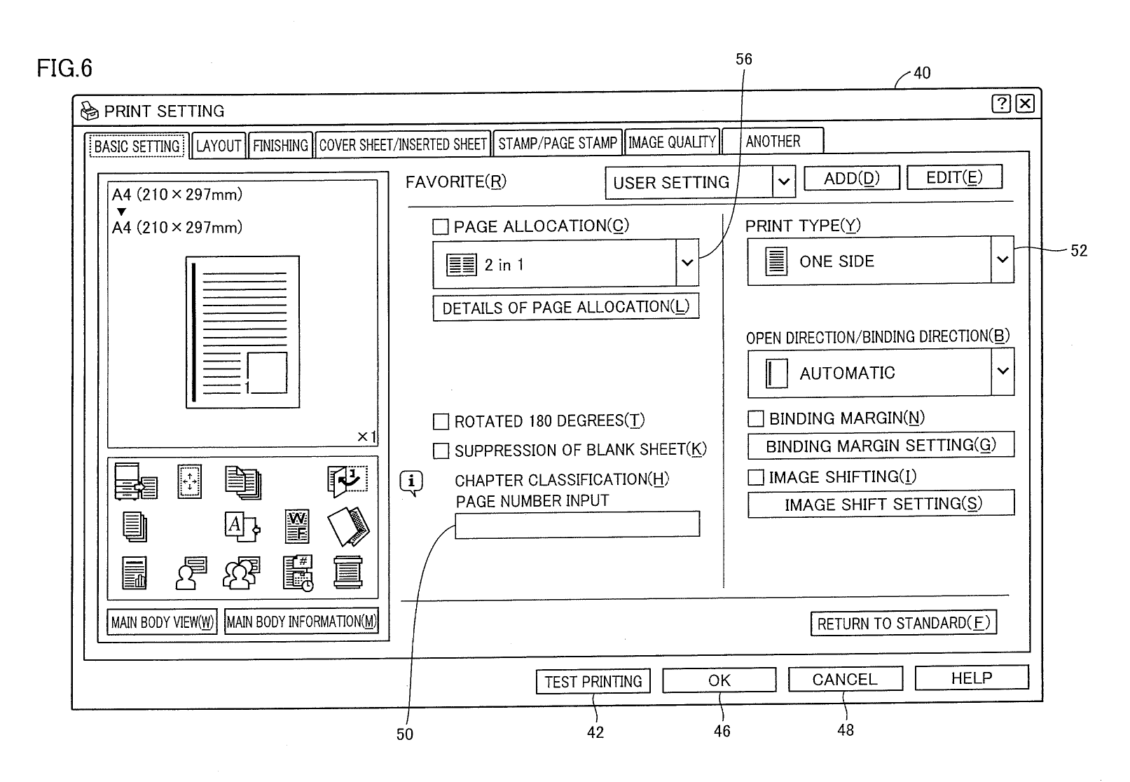

Referring to FIG. 6, a print setting screen 40 displayed at display 106 will be described hereinafter.

At print setting screen 40, various types of items related to printing environment setting can be set. Specifically, the setting related to various types of printing environment can be executed by specifying a plurality of tabs classified per setting item provided at the upper area using a mouse that is a pointing device, the keyboard, or the like.

By setting various types of tabs and setting items or the like by the mouse or the like, selection of the printing sheet, picture quality, and the like can be set.

In the present example, various types of setting items in the event of the tab of “basic setting” being specified are displayed by way of example.

An item button 52 related to the setting of the printing type is displayed, for example. By specifying item button 52 through the mouse or keyboard, the operation of modifying the setting such as “one side”, “double side” can be effected by, for example, a pull down menu.

An item button 56 for aggregate setting is provided. By specifying item button 56, an aggregate setting such as “2in1” can be set.

A page number input column 50 is also provided. The user can specify the page to be printed out through the mouse, keyboard, or the like.

The lower column represents the case where “test printing” button 42, “OK” button 46, and “cancel” button 48 are provided.

“Test printing ” button 42 functions to instruct execution of a test print setting of image data according to the display contents on the relevant print setting screen. “OK” button 46 designates execution of the printing setting of image data according to the display contents on the relevant print setting screen. “Cancel” button 48 functions to instruct termination of the print setting screen.

Referring to the flowchart of FIG. 4 again, CPU 101 determines whether there is a modification input of the setting item on the print setting screen (step S5). Specifically, CPU 101 determines whether a specified item has been modified or not on print setting screen 40 through the mouse, keyboard, or the like.

When CPU 101 determines that there is a modification input of the setting item on the print setting screen (YES at step S5), the setting contents are modified (step S5#). Then, control proceeds to step S4, i.e. the printing setting screen is updated and displayed.

When CPU 101 determines that there is no modification input of the setting item on the print setting screen (NO at step S5), CPU 101 determines whether the test print button is depressed or not (step S6). Specifically, a determination is made as to whether “test print” button 42 provided at the lower region in print setting screen 40 has been specified by input through the mouse or the like.

When CPU 101 determines that the test print button is depressed (YES at step S6), the test printing setting process is executed (step S8). Accordingly, a test printing registration process is executed (step S9). Then, the process ends. Details of the test printing setting process and test printing registration process will be described in detail afterwards.

When the test print button is not depressed at step S6 (NO at step S6), CPU 101 determines whether “OK” button 46 is depressed or not at step S10.

At step S10, when CPU 101 determines that “OK” button 46 has been depressed (YES at step S10), the setting process of normal printing will be executed (step S12). Then, the process ends (end).

When CPU 101 determines that “OK” button 46 is not depressed at step S10 (NO at step S10), an another process is executed (step S14). Then, the process ends. For example, when a determination is made that “cancel” button 48 is depressed, the display of print setting screen 40 is eliminated based on the determination that printing has been canceled.

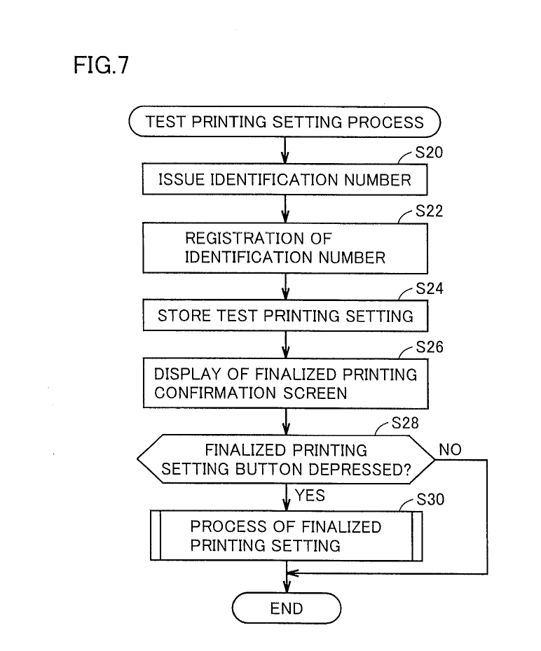

The flowchart of FIG. 7 represents a subroutine of a test printing setting process according to the first embodiment. Here, the process of mainly CPU 101 will be described.

Referring to FIG. 7, CPU 101 issues an identification number (step S20). Specifically, an identification number is issued in an ascending manner in correspondence with the file data that is the subject of printing.

Then, CPU 101 registers the issued identification number (step S22). Specifically, CPU 101 registers the issued identification number and the file name of the file data that is the subject of printing in the identification table in correspondence.

Then, CPU 101 stores the test printing setting (step S24). Specifically, CPU 101 registers the setting contents at the time of “test printing ” button 42 being depressed on print setting screen 40 as the test printing setting in the identification table.

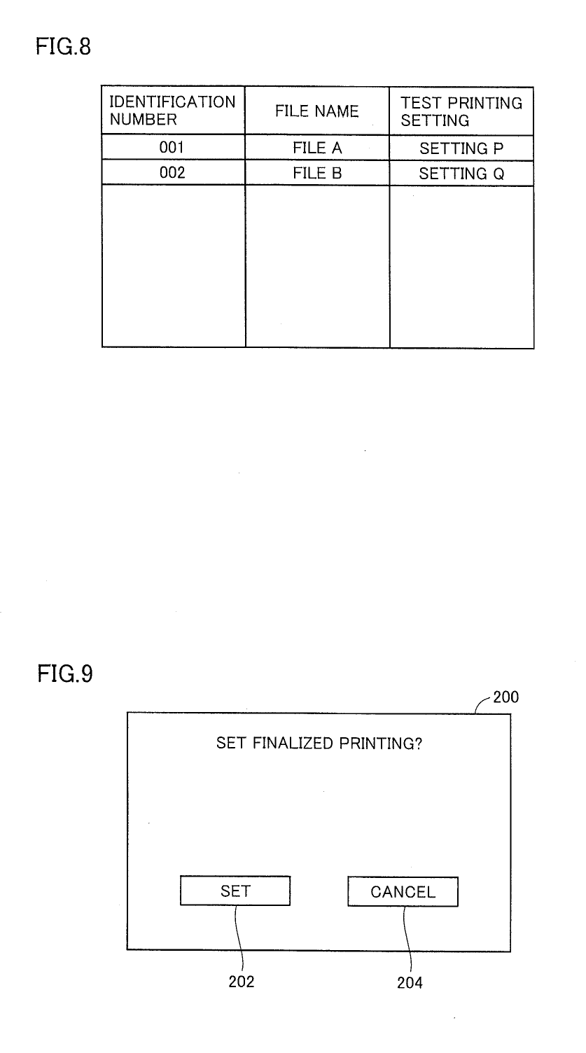

The identification table according to the first embodiment of the present invention will be described with reference to FIG. 8. An identification number is issued in an ascending manner corresponding to file data that becomes the subject of printing, and registered together with the file name of the file data. In addition, registration of a test print setting that has been set is indicated. It is assumed that this identification table is stored in HDD 104.

By way of example, “file A” is registered as the file name corresponding to identification number “001”. Also, the test print setting is registered as “setting P”. Further, “file B” is registered as the file name corresponding to identification number “002”. The test printing setting is registered as “setting Q”.

Since an identification number is issued corresponding to the file data, the identification number will be the same when the file name is identical. Therefore, in the case where there is an identical file name registered previously in the identification table, the setting contents of the test print setting will be updated.

Referring to FIG. 7 again, CPU 101 provides a display of a finalized printing confirmation screen (step S26).

A finalized printing confirmation screen 200 according to the first embodiment of the present invention will be described with reference to FIG. 9.

On finalized printing confirmation screen 200, a guidance message of “Set finalized printing?” is displayed, together with “setting” button 202 and “cancel” button 204.

The user can use a pointing device such as a mouse to select “setting” button 202, or “cancel” button 204 provided on finalized printing confirmation screen 200.

Referring to the flowchart of FIG. 7 again, CPU 101 determines whether the finalized printing setting button is depressed or not (step S28). Specifically, CPU 101 determines whether “setting” button 202 on finalized printing confirmation screen 200 of FIG. 9 is depressed or not.

At step S28, when CPU 101 determines that the finalized printing setting button is depressed (YES at step S28), the finalized printing setting process is executed (step S30).

Then the process ends (end).

When CPU 101 determines that the finalized printing setting button is not depressed at step S28 (NO at step S28), the process ends without executing the finalized printing setting process. Specifically, the process ends when CPU 101 determines that “cancel” button 204 has been depressed on finalized printing confirmation screen 200 of FIG. 9.

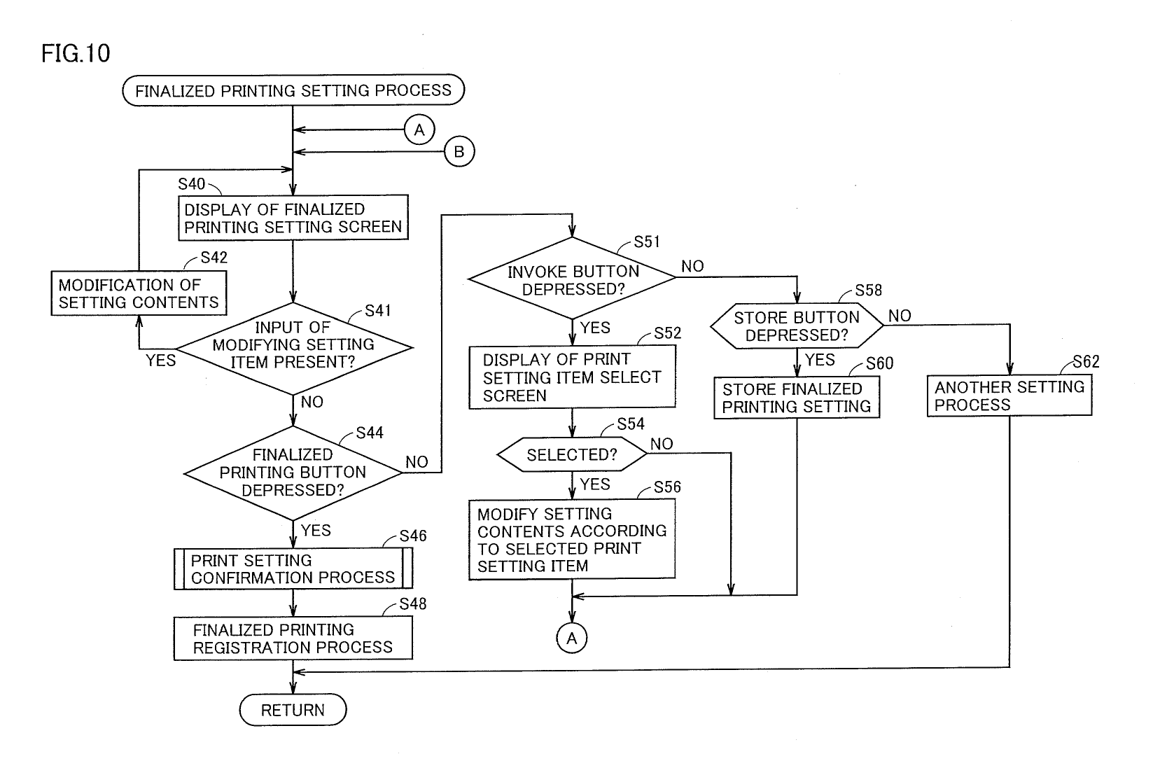

FIG. 10 is a flowchart of a finalized printing setting process according to the first embodiment of the present invention. Here, the process of mainly CPU 101 will be described.

Referring to FIG. 10, CPU 101 provides the display of a finalized printing setting screen on display 106 (step S40).

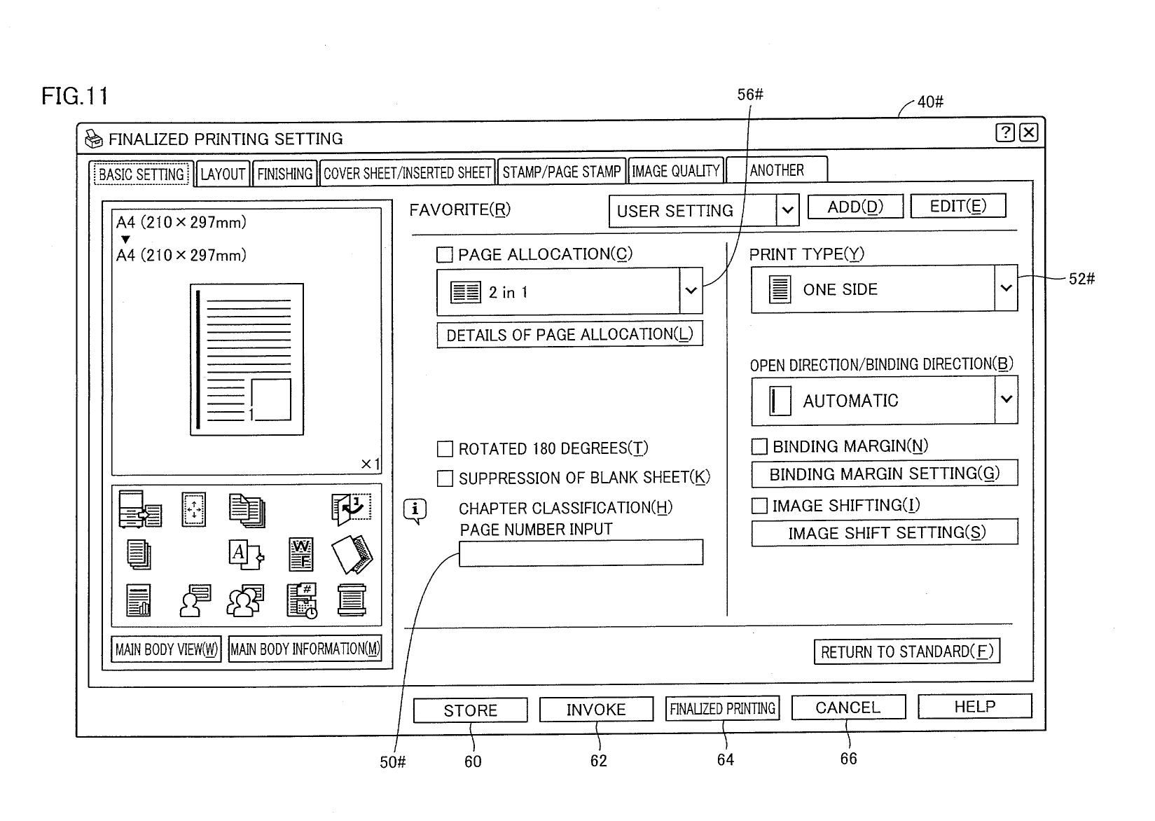

At a finalized printing setting screen 40# according to the first embodiment shown in FIG. 11, the setting of items similar to those displayed on print setting screen 40 described with reference to FIG. 6 is allowed.

At the lower column of finalized printing setting screen 40#, “store” button 60, “invoke” button 62, “finalized printing” button 64, and “cancel” button 66 are provided.

As used herein, “store” button 60 functions to instruct HDD 104 to register the display contents on the finalized printing setting screen as the setting contents for finalized printing. “Invoke” button 62 functions to invoke the setting contents of the finalized printing setting registered at HDD 104 as the display contents of the finalized printing setting screen. Further, “finalized printing” button 64 functions to instruct execution of finalized printing. “Cancel” button 66 functions to eliminate finalized printing setting screen 40#.

Additionally, a page number input column 50# is provided. The user can specify the page to be printed out through the mouse, keyboard, or the like. When not specified, a determination is made that all the pages are specified.

Referring to the flowchart of FIG. 10 again, CPU 101 determines whether there is a modification input of the setting item (step S41). Specifically, CPU 101 determines whether an item that has the setting item specified is modified or not on finalized printing setting screen 40# through the mouse, keyboard, or the like.

When CPU 101 determines that there is a modification input of a setting item on finalized printing setting screen 40# (YES at step S41), modification of the setting contents is effected (step S42). Then, the finalized printing setting screen is displayed again. In other words, the finalized printing setting screen is updated and displayed.

When CPU 101 determines that there is no modification input of a setting item on finalized printing setting screen 40# (NO at step S41), a determination is made whether “finalized printing” button 64 on finalized printing setting screen 40# is depressed or not (step S44).

When CPU 101 determines that “finalized printing” button 64 is depressed on finalized printing setting screen 40# at step S44 (YES at step S44), CPU 101 executes a print setting confirmation process (step S46). Then, a finalized printing registration process is executed (step S48). Details of the finalized printing confirmation process and finalized printing registration process will be described in detail afterwards.

Then, the process ends (returns).

When CPU 101 determines that “finalized printing” button 64 on finalized printing setting screen 40# is not depressed at step S44 (NO at step S44), a determination is made whether “invoke” button 62 on finalized printing setting screen 40# is depressed or not at step S51.

When CPU 101 determines that “invoke” button 62 is depressed at finalized printing setting screen 40# at step S51 (YES at step S51), a print setting item select screen is displayed (step S52).

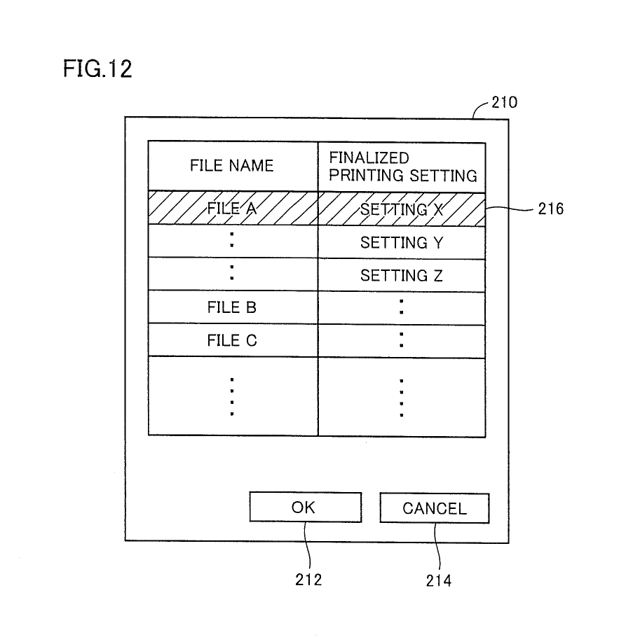

A print setting item select screen 210 shown in FIG. 12 corresponds to the case where a list of print setting items is displayed. For a file with the file name A, three types of settings X, Y and Z are displayed as the setting contents of finalized printing setting. The setting contents of finalized printing setting for each file are stored in HDD 104. The time and date may be displayed additionally so as to identify when the setting has been input. By providing such a display screen, the user can readily confirm previous settings. Furthermore, in the case where there are a plurality of setting items, update of the finalized printing setting screen readily to the setting contents according to the desired setting item selected by the user is allowed, affording convenience to the user.

For example, the user can specify item 216 using the mouse or the like to achieve a selected state. Further, depression of “OK” button 212 ascertains the selection. The depression of “cancel” button 214 causes the select screen to be erased.

The setting item for a file other than file A is also displayed. The setting item for another file such as file B may be selected. Accordingly, the setting contents can be used for file B, for example, that is analogous to file A, affording convenience to the user.

Referring to the flowchart of FIG. 10 again, when CPU 101 determines that a printing setting item is selected on print setting item select screen 210 at step S54 (YES at step S54), i.e. when a select item is selected and “OK” button 212 is depressed, the setting contents in accordance with the selected print setting item is modified (step S56). Then, control returns to step S40. In other words, CPU 101 displays the updated finalized printing setting screen on display 106.

When CPU 101 determines that a print setting item has not been selected on print setting item select screen 210 (NO at step S54), i.e. when “cancel” button 214 is depressed, print setting item select screen 210 is erased, and control returns to step S40. Namely, CPU 101 displays the finalized printing setting screen again on display 106.

When CPU 101 determines that “invoke” button 62 has not been depressed at step S51 (NO at step S51), a determination is made as to whether “store” button 60 is depressed or not (step S58).

When CPU 101 determines that “store” button 60 is depressed at step S58 (YES at step S58), the finalized printing setting is stored (step S60). Specifically, CPU 101 stores the setting contents at the time of “store” button 60 being depressed on finalized printing setting screen 40# as the finalized printing setting. Therefore, when “invoke” button 62, for example, is depressed, the item of the newly stored finalized printing setting is added and displayed on print setting item select screen 210.

Then, control returns to step S40 again.

When CPU 101 determines that “store” button 60 is not depressed at step S58 (NO at step S58), another setting process is executed (step S62). Then, the process ends (return). Specifically, when “cancel” button 66 is depressed, the process ends without effecting the print setting for finalized printing.

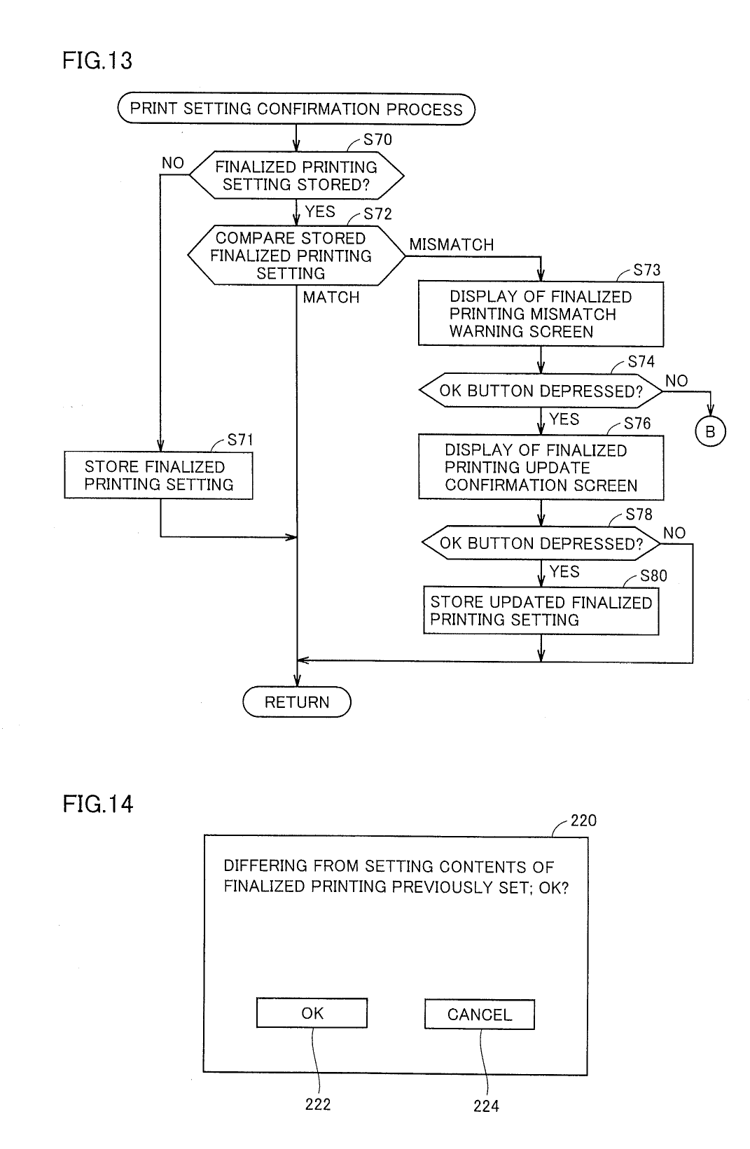

Referring to the flowchart of FIG. 13 representing a printing setting confirmation process of the first embodiment, CPU 101 determines whether a finalized printing setting is stored or not (step S70).

When CPU 101 determines that there is no finalized printing setting stored at step S70 (NO at step S70), the setting contents at the time of “finalized printing” button 64 being depressed on finalized printing setting screen 40# is stored as the finalized printing setting (step S71). Specifically, the setting contents of the finalized printing setting is stored in association with a file at HDD 104. Then, the process ends (return). In the case where no finalized printing setting is stored, the relevant setting content will be stored to be used as the subject of comparison subsequently, which will be described afterwards.

When CPU 101 determines at step S70 that finalized printing setting is stored (YES at step S70), CPU 101 compares the setting contents of the finalized printing setting on finalized printing setting screen 40# with the setting contents of finalized printing previously stored in HDD 104 (step S72). In the case where there a plurality of previous setting contents of finalized printing stored in HDD 104, comparison is made with the latest setting contents.

Then, in the case where the setting contents of finalized printing on finalized printing setting screen 40# matches the setting contents of finalized printing previously stored, the process ends (return). In other words, the setting contents of finalized printing stored previously will be used since the setting contents have not been modified in this case.

In the case where the setting contents of finalized printing on finalized printing setting screen 40# does not match the setting contents of finalized printing previously stored (step S72), CPU 101 displays on display 106 a finalized printing mismatch warning screen (step S73).

Referring to FIG. 14 representing a finalized printing mismatch warning screen 220 according to the first embodiment, the message of “Differing from setting contents of finalized printing previously set; OK?” is displayed together with “OK” button 222 and “cancel” button 224. Attention is drawn to the user by displaying the relevant screen to notify that the setting differs from the previous setting, allowing erroneous printing to be prevented.

The user can select “OK” button 222 or “cancel” button 224 using the mouse or the like.

Referring to the flowchart of FIG. 13 again, CPU 101 determines whether “OK” button 222 is depressed on finalized printing mismatch warning screen 220 (step S74).

When CPU 101 determines that “OK” button 222 is depressed on finalized printing mismatch warning screen 220 at step S74 (YES at step S74), a finalized printing update confirmation screen is displayed (step S76).

When CPU 101 determines that “OK” button 222 is not depressed on finalized printing mismatch warning screen 220 at step S74 (NO at step S74), i.e. when a determination is made that “cancel” button 224 is depressed, control returns to step S40 based on the assumption that the user wishes to revise the setting of finalized printing.

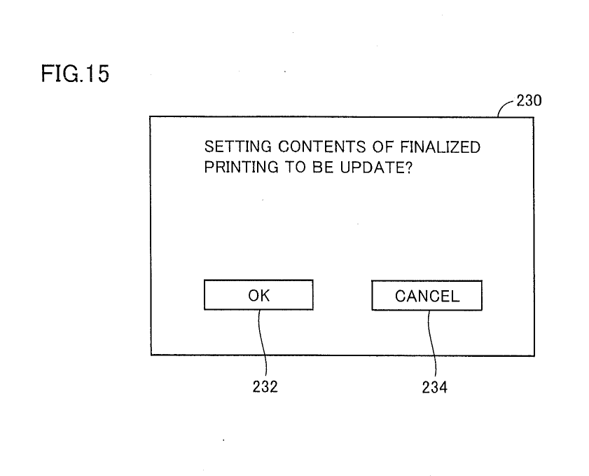

FIG. 15 represents a finalized printing update confirmation screen according to the first embodiment of the present invention.

Referring to FIG. 15, the message of “ Setting contents of finalized printing to be updated?” appears on finalized printing update confirmation screen 230, together with “OK” button 232 and “cancel” button 234.

The user can select “OK” button 232 or “cancel” 234 using the mouse or the like.

Referring to the flowchart of FIG. 13 again, CPU 101 determines whether “OK” button 232 on finalized printing update confirmation screen 230 is depressed or not (step S78).

When CPU 101 determines that “OK” button 232 is depressed on finalized printing update confirmation screen 230 at step S78 (YES at step S78), the setting contents of finalized printing on the updated finalized printing setting screen 40# is stored (step S80). Specifically, the setting contents of finalized printing on the updated finalized printing setting screen 40# is stored in correspondence with a file at HDD 104. Then, the process ends (return). Thus, a setting item of the setting contents of finalized printing is added.

Although the above description is based on a case where the items of a plurality of setting contents for finalized printings can be registered relative to one file at HDD 104, the system may be established such that only the setting contents of one finalized printing relative to one file may be registered.

When CPU 101 determines at step S78 that “OK” button 232 on finalized printing update confirmation screen 230 has not been depressed (NO at step S78), step S80 is skipped, and the process ends (return). Specifically, when “cancel” button 234 on finalized printing update confirmation screen 230 is depressed, the process ends.

Referring to the flowchart of FIG. 10, following a print setting confirmation process (step S46), a finalized printing registration process is executed (step S48). Specifically, a registration process of executing finalized printing according to the finalized printing setting is executed. Then, the finalized printing setting process ends (return). In addition, the test printing setting process ends.

Referring to the flowchart of FIG. 4 again, a test printing registration process is executed (step S9). Specifically, a registration process of executing test printing according to the test printing setting is executed. Then, the activation of the printer driver is terminated (end).

Accordingly, CPU 101 notifies the application that opens the file data from the printer driver about the print setting.

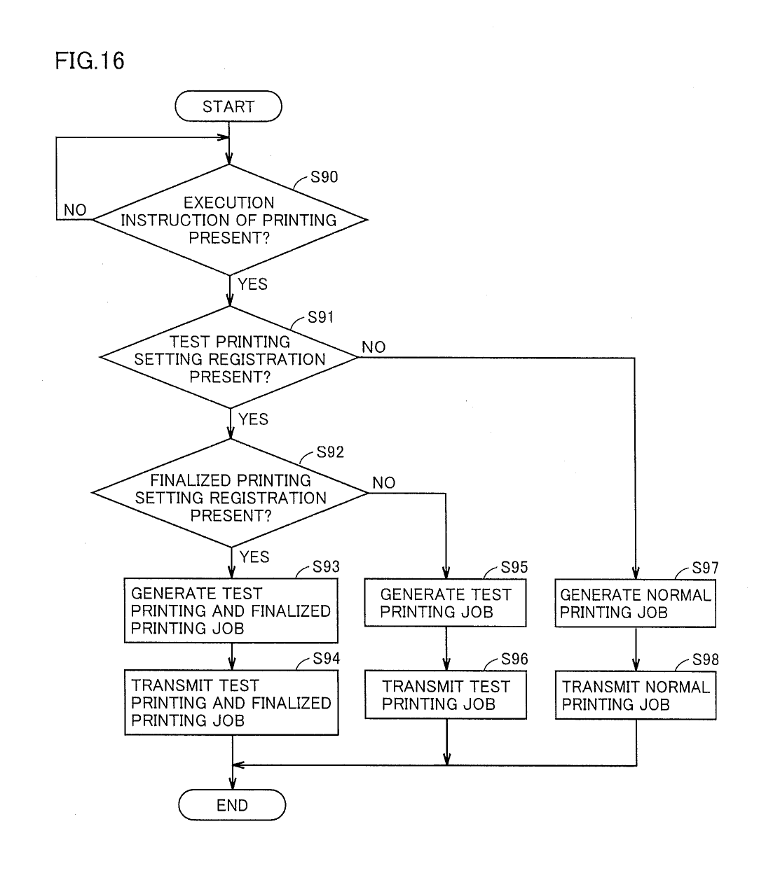

A print execution process of file data will be described hereinafter with reference to the flowchart of FIG. 16, mainly on part of CPU 101.

At step S90, a determination is made as to whether print execution is instructed or not. Specifically, the determination is made based on whether execution of “print” button 34 on print dialog screen 30 of the application is instructed or not.

When a determination is made that print execution is instructed at step S90 (YES at step S90), a determination is made as to whether there is a registration of test printing setting or not (step S91). Specifically, the determination is made based on whether a registration process of test printing setting has been executed or not.

When a determination is made that there is a registration of test printing setting at step S91 (YES at step S91), control proceeds to step S92 to determine whether there is a registration of finalized printing setting. Specifically, the determination is made based on whether the above-described finalized printing setting registration process has been executed or not.

When a determination is made that there is registration of finalized printing setting at step S92 (YES at step S92), CPU 101 sends the registered test printing and finalized printing setting from the application to the printer driver. A test printing job and finalized printing job are generated based on the sent test printing and finalized printing settings as well as the file data that is the subject of printing, according to the file name that is the subject of printing (step S93).

Specifically, at step S93, the mode is set at the test print mode. The file data that is the subject of printing is read out, and a test printing job is generated based on the test printing setting. When the file data is read out up to the end of the relevant file (that is, when the end signal (EOF) is read out), a determination is made that generation of a test printing job has ended, and the test print mode is terminated. Then, the file data is read out again, and a finalized printing job is generated based on the finalized printing setting. When the file data is read out up to the end of the relevant file (that is, when the end signal (EOF) is read out again), a determination is made that generation of a finalized printing job has ended, and generation of a finalized printing job is completed.

The generated test printing job and finalized printing job are sequentially transmitted to MFP 10 (step S94). Specifically, CPU 101 transmits the test printing job and finalized printing job to MFP 10 connected on network 5 via network interface card 108. Since the amount of data is greater for the finalized printing job, the test printing job is generated and transmitted prior to the finalized printing job. Thus, the process ends (end).

When a determination is made that there is no registration of finalized printing setting at step S92 (NO at step S92), only the registered test print setting is sent by CPU 101 from the application to the printer driver. A test printing job is generated based on the sent test print setting and the file data that is the subject of printing, according to the file name that is the subject of printing (step S95). Then, the generated test printing job is transmitted (step S96). Specifically, CPU 101 transmits the test printing job to MFP 10 connected on network 5 via network interface card 108. Thus, the process ends.

When a determination is made that there is no registration of test print setting at step S91 (NO at step S91), CPU 101 sends the normal printing setting from the application to the printer driver. A normal print job is generated based on the sent normal print setting and file data that is the subject of printing, according to the file name that is the subject of printing (step S97).

Specifically, CPU 101 transmits the normal printing job to MFP 10 connected on network 5 via network interface card 108 (step S98). Then, the process ends.

The process on the MFP side receiving a printing job will be described hereinafter.

<MFP Process>

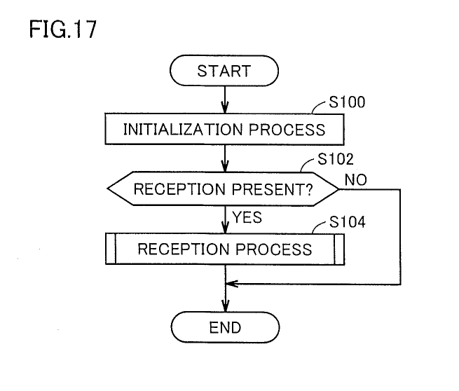

FIG. 17 is a flowchart of the reception flow at MFP 10 according to the first embodiment of the present invention. Here, the process of CPU 11 will be mainly described.

Referring to FIG. 17, when the power is turned on, CPU 11 executes an initialization process (step S100). Specifically, CPU 11 loads the program stored in ROM 13 and provides setting such that execution of various functions are allowed. By way of example, the setting is established such that data can be transmitted and received to and from an external source via network 5 by means of NIC 16.

Then, CPU 11 determines whether there is a reception (step S102). It is assumed that the received data, the test printing job that will be described afterwards, and the like are stored in RAM 12 or the like.

When CPU 11 determines that there is a reception at step S102 (YES at step S102), a reception process is executed at step S104. The reception process will be described afterwards. When there is no reception (NO at step S102), the process ends. The present example corresponds to the case where a test printing job and finalized printing job are transmitted from PC 100 and the like.

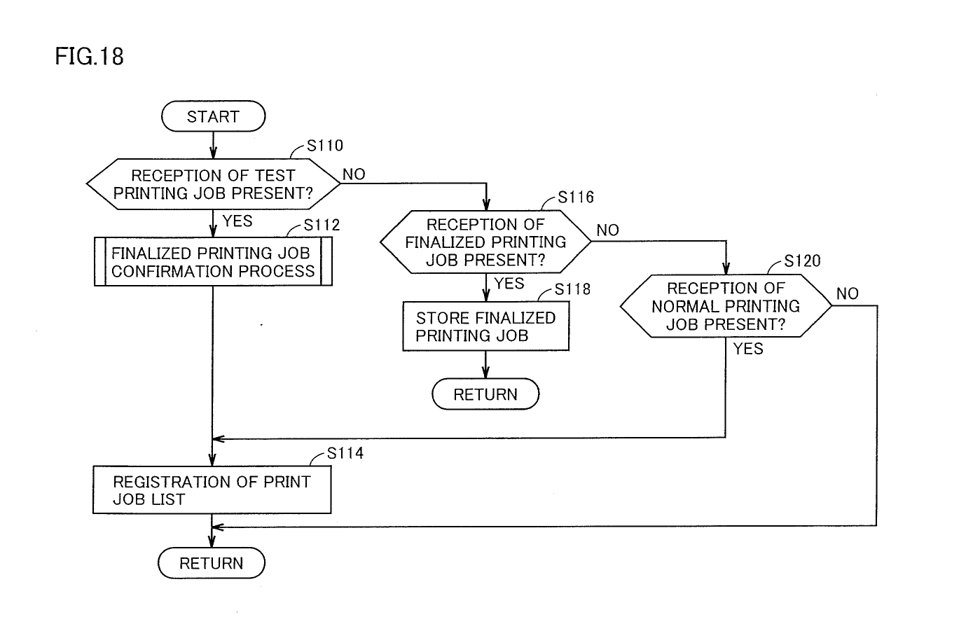

FIG. 18 is a flowchart of a reception process according to the first embodiment of the present invention. The process of CPU 11 will be mainly described.

Referring to FIG. 18, CPU 11 determines whether a test printing job is received or not at step S110.

When CPU 11 determines that a test printing job is received (YES at step S110), a finalized printing job confirmation process is executed at step S112. The finalized printing job confirmation process will be described afterwards.

At step S114, CPU 11 registers the received test printing job in the print job list. Then, the process ends (return).

When CPU 11 determines at step S110 that there is no reception of a test printing job (NO at step S110), a determination is made as to whether there is a reception of a finalized printing print job at step S116.

When CPU 11 determines that there is a reception of a finalized printing job at step S116 (YES at step S116), the finalized printing job is stored (at step S118). Specifically, CPU 11 stores the received finalized printing job into HDD 15. Then, the process ends (return).

When CPU 11 determines that there is no reception of a finalized printing job at step S116 (NO at step S116), a determination is made as to whether a normal printing job is received or not (step S120).

When CPU 11 determines that there is a reception of a normal print job at step S120 (YES at step S120), control proceeds to step S114 to register into the print job list.

When CPU 11 determines that there is no reception of a normal printing job at step S120 (NO at step S120), the process ends (return).

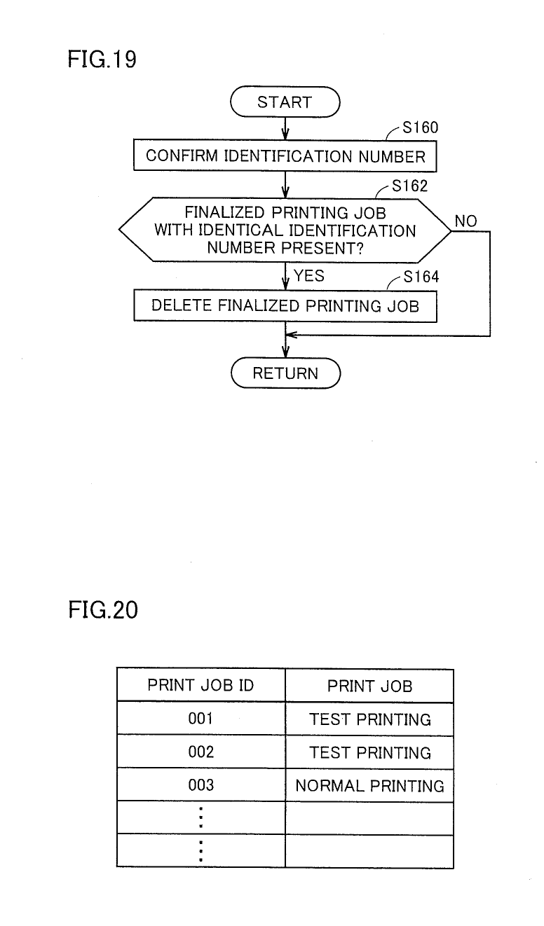

FIG. 19 is a flowchart of a finalized printing job confirmation process according to the first embodiment of the present invention. Here, the process at CPU 11 will be mainly described.

Referring to FIG. 19, CPU 11 confirms the identification number at step S160. Specifically, the identification number issued associated with the file data included in the test printing job is confirmed.

Then, CPU 11 determines whether there is a finalized printing job having an identical identification number at step S162. Specifically, CPU 11 confirms whether the identification number issued associated with the file data included in the finalized printing job stored in HDD 15 is identical to the identification number included in the test printing job confirmed at step S160.

When CPU 11 determines at step S162 that there is a finalized printing job having the same identification number (YES at step S162), the finalized printing job is deleted (step S164). Specifically, when a finalized printing job having an identification number identical to the identification number included in the test printing job is stored in HDD 15, the stored finalized printing job will be deleted. Then, the process ends (return).

When CPU 11 determines that there is no finalized printing job having the same identification number at step S162 (NO at step S162), i.e. when a finalized printing job having an identification number identical to the identification number included in the test printing job is not stored in HDD 15, the process ends (return) without deleting the finalized printing job.

There may be the case where a test printing job is received, and a finalized printing job having an identification number identical to that included in that test printing job in HDD 15 is already stored. This corresponds to the case where the test printing job is revised again. In such a case, it is considered that the possibility of executing the finalized printing job stored in HDD 15 corresponding to the old test printing job is low. Therefore, by deleting the older finalized printing job when a new test printing job is received, accumulation of an old finalized printing job in HDD 15 is prevented, allowing the effective usage of the memory.

FIG. 20 represents a print job list according to the first embodiment of the present invention. FIG. 20 corresponds to the case where a plurality of print jobs are registered in the list, and a print job ID is issued in the registered order. It is assumed that the print job list is stored in HDD 15.

Specifically, print job IDs “001”-“003” are issued. A “test printing job ” is registered corresponding to each of print job IDs “001”-“003”. Similarly, a “normal printing job” corresponding to print job “003” is registered.

It is assumed that a printing process is executed in order for every print job ID.

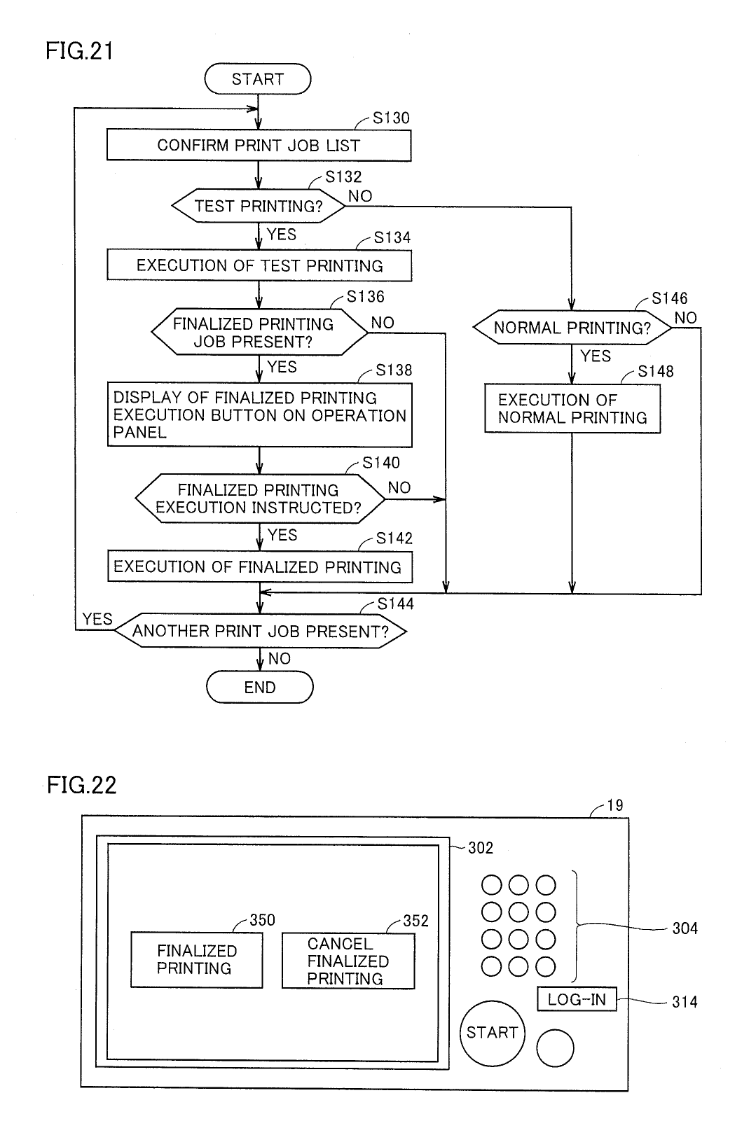

FIG. 21 is a flowchart of the printing process at MFP 10 according to the first embodiment of the present invention. Here, the process of CPU 11 will be mainly described. It is assumed that the reception process and printing process are carried out independent of each other.

Referring to FIG. 21, CPU 11 first confirms the print job list at step S130.

Then, CPU 11 determines whether the printing job corresponds to test printing or not at step S132.

When CPU 11 determines that the printing job corresponds to test printing at step S132 (YES at step S132), test printing is executed at step S134. Specifically, a test printing job is output to printer 18. At printer 18, a printing process corresponding to the test printing job is executed.

Then, CPU 11 determines whether a finalized printing job is stored or not at step S 136. Specifically, CPU 11 determines whether a finalized printing job having an identification number identical to that included in the test printing job stored in HDD 15 is stored or not.

When CPU 11 determines that a finalized printing job is stored at step S136 (YES at step S136), a finalized printing execution button is displayed on operation panel 19 at step S138.

Operation panel 19 according to the first embodiment of the present invention will be described with reference to FIG. 22.

Referring to FIG. 22, a display 302, ten key 304, a log-in button 314, and the like are provided on operation panel 19.

The present example corresponds to the case where finalized printing execution button 350 and finalized printing cancel button 352 are displayed on display 302. Display 302 corresponds to a touch panel. An input can be designated by the user touching a desired item using his/her finger or the like. In other words, an input can be instructed by touching finalized printing execution button 350. The finalized printing can be canceled by touching finalized printing cancel button 352.

Referring to FIG. 21, again, CPU 11 determines whether finalized printing execution is instructed at step S140. Specifically, a determination is made as to whether an input instruction of finalized printing execution button 350 is designated on operation panel 19.

When CPU 11 determines that finalized printing print execution is instructed at step S140 (YES at step S140), finalized printing is executed at step S142. Specifically, a finalized printing job having an identification number identical to that included in the test printing job stored in HDD 15 is output to printer 18. At printer 18, a printing process corresponding to the finalized printing job is executed.

Then, CPU 11 determines whether there is another printing job at step S144. When CPU 11 determines that there is another printing job at step S144 (YES at step S144), control returns to step S130 to repeat a similar process.

When CPU 11 determines that there is no other printing job at step S144 (NO at step S144), the process ends.

When CPU 11 determines that the printing job does not correspond to test printing at step S132 (NO at step S132), a determination is made as to whether the printing corresponds to normal printing at step S146.

When CPU 11 determines that the print job corresponds to normal printing at step S146 (YES at step S146), normal printing is executed at step S148. Specifically, the normal printing job is output to printer 18. At printer 18, a printing process corresponding to the normal printing job is executed.

When CPU 11 determines that the print job does not correspond to normal printing at step S146 (NO at step S146), control proceeds to step S144.

Also, when a determination is made that there is no finalized printing job at step S136 (NO at step S136), control proceeds to step S144. For example, only test printing will be executed in the case where only a test printing job is received.

Furthermore, control proceeds to step S144 also in the case where there is no instruction of executing finalized printing (NO at step S140). Specifically, a determination is made as to whether an input of finalized printing cancel button 352 is instructed on operation panel 19. When there is instruction of an input of finalized printing cancel button 352, control proceeds to step S144. This includes the case where the user requests revision of test printing after confirming the executed result of test printing.

When test printing carried out at an image formation apparatus is confirmed and considered to be satisfactory in the conventional system, execution of finalized printing had to be instructed by operating the computer again, which required cumbersome operation. The system of the present embodiment allows execution of finalized printing by the user instructing an input of finalized printing execution button 350 displayed on operation panel 19 of MFP 10 in the case where the user confirms the executed result of test printing. Thus, test printing and finalized printing can be executed readily.

In the present system, the user can specify the page to be executed for test printing on a print setting screen 40 of FIG. 6 by means of the mouse or keyboard in test printing. In the case where the file data that is the subject of printing includes image data of many pages in the conventional system, the time required for the storing process was lengthy since the printing of the specified pages could be executed only after the file data has been completely stored. In the system of the present embodiment, a test printing job including only the data of the required pages can be received independent of the finalized printing job, allowing execution of high-speed printing for test printing.

### Second Embodiment

The previous first embodiment allows finalized printing to be executed by instructing an input of a finalized printing execution button that is displayed on the operation panel, following execution of a test printing job. In the case where MFP 10 is shared, it may be desirable to improve the security by allowing finalized printing to be executed by only the original person.

The second embodiment of the present invention is directed to a system of executing a finalized printing job corresponding to a user with succeeding authentication.

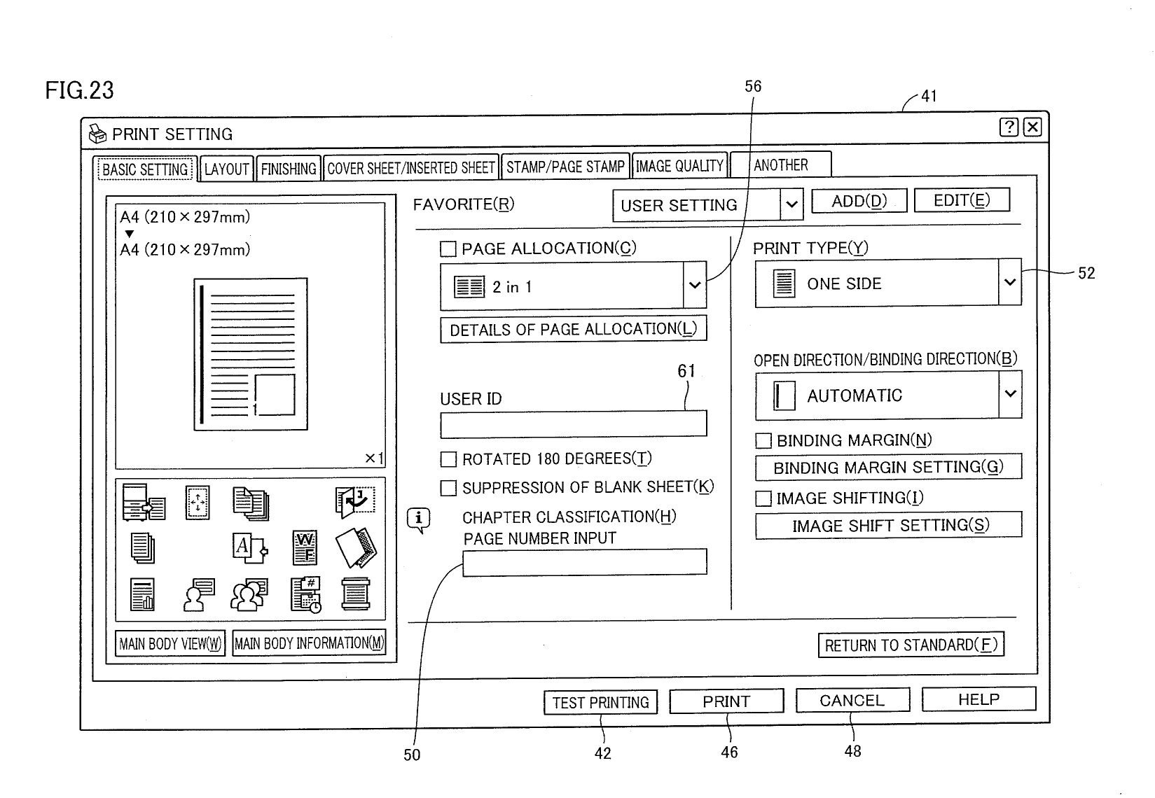

A print setting screen 41 according to the second embodiment of the present invention shown in FIG. 23 differs from the print setting screen of the first embodiment shown in FIG. 6 in that a user ID region column 61 is provided.

Region column 61 allows a user ID to be input. It is assumed that the user enters a user ID identical to the user ID registered at MFP 10.

A test printing job and finalized printing job can be transmitted to MFP 10 likewise with the system described in the first embodiment.

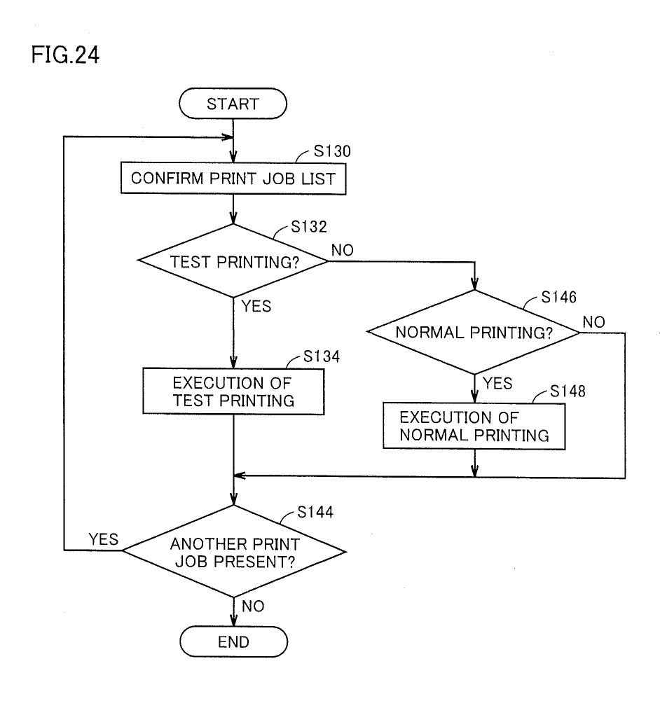

FIG. 24 is a flowchart of the printing process at MFP 10 according to the second embodiment of the present invention. Here, the process of mainly CPU 11 will be described. It is assumed that the reception process and printing process are carried out independent of each other.

Referring to FIG. 24, CPU 11 first confirms the print job list at step S130.

Then, CPU 11 determines whether the print job corresponds to test printing or not at step S132.

When the print job corresponds to test printing at step S132 (YES at step S132), CPU 11 executes test printing (step S134). Specifically, the test printing job is output to printer 18. At printer 18, a printing process corresponding to the test printing job is executed.

Then, CPU 11 determines whether there is another printing job at step S144.

When a determination is made that there is another printing job at step S144 (YES at step S144), control returns to step S130 where CPU 11 repeats a similar process.

In contrast, when a determination is made that there is no other print job at step S144 (NO at step S144), the process ends (end).

Further, when a determination is made that the print job does not correspond to test printing at step S132 (NO at step S132), CPU 11 determines whether the job corresponds to normal printing or not at step S146.

When a determination is made that the printing corresponds to normal printing at step S146 (YES at step S146), CPU 11 executes normal printing at step S148.

When CPU 11 determines that the job does not correspond to normal printing at step S146 (NO at step S146), control proceeds to step S144.

In the system according to the second embodiment of the present invention, the finalized printing execution button is not displayed on the operation panel when test printing is executed.

Further, in the case where the user has not logged in, only test printing and normal printing is executed, and finalized printing will not be executed.

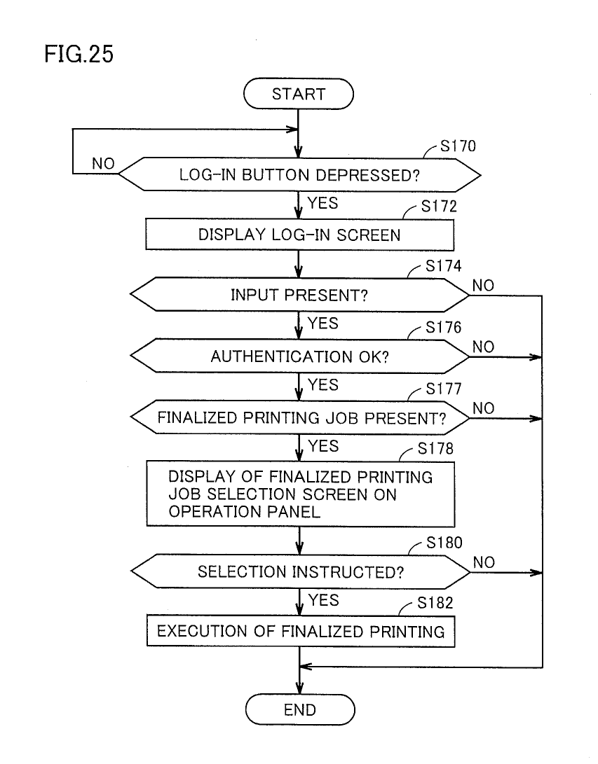

FIG. 25 is a flowchart of the finalized printing process at MFP 10 according to the second embodiment of the present invention. Here, the process of mainly CPU 11 will be described.

Referring to FIG. 25, CPU 11 determines whether the log-in button is depressed or not at step S170. Specifically, a determination is made as to whether log-in button 314 described with reference to FIG. 20 is depressed or not.

When CPU 11 determines that the log-in button is depressed (YES at step S170), a log-in screen is displayed on display 302 of operation panel 19 (step S172).

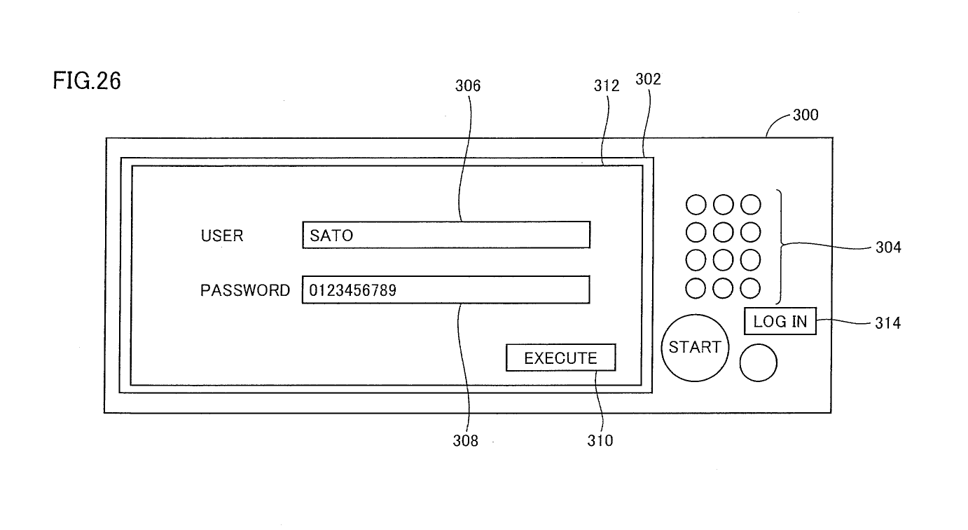

FIG. 26 represents a log-in screen displayed on the operation panel according to the second embodiment of the present invention.

Operation panel 19 of FIG. 26 corresponds to the case where log-in screen 312 is displayed on display 302 in response to the depression of log-in button 314.

Log-in screen 312 corresponds to the case where a user ID input column 306, a password input column 308, and an “execution” button 310 are provided.

The user enters his/her own registered authentication information into user ID input column 306 and password input column 308 on log-in screen 312, and depresses “execution” button 310 to execute the authentication process.

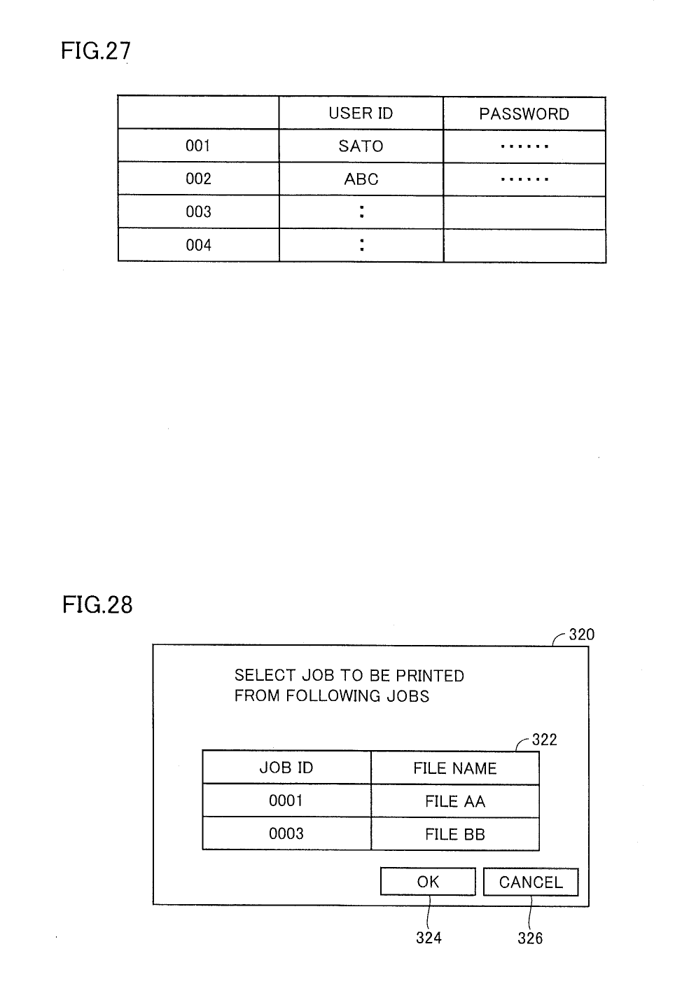

FIG. 27 represents an authentication table registered in MFP 10 according to the second embodiment of the present invention.

In FIG. 27, the authentication table is indicated having authentication information registered.

Specifically, a user ID or the like is registered with a registration number assigned in the order of registration. The present example represents the case where a user ID and a password are registered corresponding to a registration number.

By way of example, user ID “SATO” is registered corresponding to registration number “001”. Also, user ID “ABC” is registered corresponding to registration number “002”.

Referring to the flowchart of FIG. 25 again, CPU 11 determines whether there is an input on the log-in screen at step S174.

When CPU 11 determines that there is an input on the log-in screen at step S174 (YES at step S174), a determination is made as to whether the authentication is OK or not at step S176.

When CPU 11 determines that the authentication is OK at step S176 (YES at step S176), a determination is made as to whether a finalized printing job is stored or not at step S177.

Specifically, a determination is made as to whether a finalized printing job having a user ID identical to the authenticated user ID is stored in HDD 15.

When CPU 11 determines at step S177 that a finalized printing job is stored (YES at step S177), a finalized printing job select screen is displayed on operation panel 19 (step S178). Specifically, a finalized printing job select screen is displayed after confirmation of the finalized printing job including the same user ID stored in HDD 15.

FIG. 28 represents a finalized printing job select screen according to the second embodiment of the present invention.

Referring to FIG. 28, a list of stored finalized printing jobs corresponding to authorized authentication, i.e. the user ID succeeding in authentication, is displayed on finalized printing job select screen 320.

By way of example, a print job having the file name “file AA” corresponding to the job ID of “0001” and a print job having the file name “file BB” corresponding to the job ID of “0003” are displayed in the list.

The user can select from the list displayed on finalized printing job select screen 320 the printing job he/she wishes to be printed out. For example, the user can specify a select item 322 of a printing job with the file name “file AA” corresponding to the job ID of “0001”.

Then, the user can depress “OK” button 324 to designate selection of the finalized printing job. If “cancel” button 326 is depressed, the process proceeds with no selection of a print job.

Referring to the flowchart of FIG. 25 again, CPU 11 determines whether selection of a finalized printing job is instructed or not at step S180. Specifically, CPU 11 determines whether a selection item is specified and “OK” button 324 is depressed on finalized printing job select screen 320.

When CPU 11 determines that there is a selection designation of a finalized printing job (YES at step S180), CPU 11 executes finalized printing (step S182). Specifically, the finalized printing job is output to printer 18. At printer 18, a printing process on the finalized printing job is executed.

Then, the process ends (end).

According to the system of the second embodiment, execution of one's own stored finalized printing job is allowed only when authentication succeeds. Thus, the security can be improved.

Additionally, a program can be provided to cause a computer to function so as to execute such control described with reference to the flowcharts. The program can be recorded on a computer-readable recording medium such as a flexible disk that comes with the computer, a CD-ROM (Compact Disk-Read Only Memory), a ROM (Read Only Memory), a RAM (Random Access Memory), or a memory card to be presented as a program product. Alternatively, the program can be recorded on a recording medium such as a hard disk incorporated in the computer to be provided. Further alternatively, the program can be presented by being down loaded through a network.

The program may be directed to executing a process upon invoking the necessary module from the program module presented as a part of the operating system (OS) of the computer, at a predetermined timing and in a predetermined array. In this case, the program per se does not include the aforementioned module, and the process is executed in cooperation with the OS. Such a program that does not include a module may read on the program of the present invention.

Furthermore, the program of the present invention may be incorporated into a portion of another program to be presented. Similarly in this case, the module included in another program set forth above is not included in the program per se, and the process is executed in cooperation with another program. A program embedded in such another program may read on the program of the present invention.

The presented program product is installed in a program storage unit such as a hard disk to be executed. The program product includes a program per se, and a recording medium on which the program is recorded.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An information processing apparatus transmitting image data produced through application software to an image formation apparatus for printing, said information processing apparatus comprising:
a display capable of displaying a setting screen directed to printing said image data,
a transmitter transmitting data to said image formation apparatus, and
a controller controlling said image information processing apparatus totally,
said controller configured to
determine whether an input of a setting execution instruction of test printing at the setting screen of image data displayed on said display is accepted;
display, on said display, a setting screen directed to finalized printing differing from said test printing when an input of a setting execution instruction of test printing at said setting screen is accepted;
determine whether an input of a setting execution instruction at said setting screen directed to finalized printing is accepted;
generate a first print job directed to executing test printing of said image data when an input of a setting execution instruction at said setting screen directed to finalized printing is accepted, said first print job including first print data that is a version of the image data converted based on an input of the setting execution instruction of test printing;
transmit said generated first print job to said image formation apparatus via said transmitter;
generate a second print job directed to executing finalized printing of said image data, after said first print job is transmitted, said second print job including second print data that is a version of said image data converted based on an input of a setting execution instruction of finalized printing; and
transmit said generated second print job to said image formation apparatus via said transmitter.

2. The information processing apparatus according to claim 1, wherein said controller is configured to
issue identification information corresponding to said image data when an input of a setting execution instruction of said test printing at said setting screen is accepted, and
generate said first print job including said first print data and said identification information when an input of a setting execution instruction at said setting screen of finalized printing is accepted.

3. The information processing apparatus according to claim 2, wherein said controller is configured to generate, after said first print job is transmitted, said second print job including said second print data and said identification information.

4. The information processing apparatus according to claim 1, wherein said controller is configured to accept an input of specified page data in said test printing of said image data constituted of multiple page data at said setting screen.

5. The information processing apparatus according to claim 1, further comprising a memory,
wherein said controller is configured to
determine whether an input of a modifying instruction of setting contents at said setting screen directed to finalized printing is accepted,
update and display on said display said setting screen directed to finalized printing when an input of a modifying instruction at said setting screen directed to finalized printing is accepted,
determine whether an input of an instruction to store setting information indicating setting contents at said setting screen directed to finalized printing is accepted, and
store in said memory said setting information that can be used for the setting contents at said setting screen directed to finalized printing, when an input of an instruction to store at said setting screen directed to finalized printing is accepted

6. The information processing apparatus according to claim 5, wherein said controller is configured to
compare setting information indicating setting contents at said setting screen directed to finalized printing with said setting information stored in said memory, based on an input of a setting execution instruction of said finalized printing, and
display a confirmation screen of the setting contents at said display when the setting information differ from each other based on the comparison.

7. The information processing apparatus according to claim 5, wherein said controller is configured to
store, in said memory, setting information indicating setting contents at said setting screen directed to finalized printing associated with the identification information identifying said image data, when an input of an instruction to store at said setting screen directed to finalized printing is accepted,
store, in said memory, another setting information associated with said identification information according to update of the setting contents at said setting screen directed to finalized printing, when an input of an instruction to store at said setting screen directed to finalized printing is accepted a plurality of times.

8. The information processing apparatus according to claim 7, wherein said controller is configured to
determine whether an input of an instruction to read out the setting information stored in said memory, appearing at said setting screen directed to finalized printing, is accepted, and
when an input of an instruction to read out at said setting screen directed to finalized printing is accepted, display on said display a select screen allowing selection of one of a plurality of setting information associated with said identification information stored in said memory.

9. An image formation apparatus printing image data produced through application software of an information processing apparatus, said image formation apparatus comprising:
a receiver receiving first print data directed to executing test printing of said image data transmitted from said information processing apparatus, and second print data directed to executing finalized printing of said image data transmitted together with said first print data,
a printer executing an image formation process,
a memory, and
a controller controlling said image formation apparatus totally,
said controller configured to
determine whether said first print data is received or not via said receiver,
when said first print data is received, providing said first print data to said printer for executing said image formation process,
determine whether said second print data is received or not via said receiver, and
when said second print data is received, store said second print data in said memory.

10. The image formation apparatus according to claim 9, wherein said first and second print data include identification information associated with said image data,
wherein said controller is configured to
determine whether identification information included in the first print data is identical to the identification information included in said second print data stored in said memory, when said first print data is received, and
when a determination is made that the identification information are identical, erasing said second print data including said identical identification information stored in said memory.

11. The image formation apparatus according to claim 9, wherein said first and second print data include identification information associated with said image data,
said image formation apparatus further comprising a display,
wherein said controller is configured to
determine, after the image formation process of said first print data ends, whether there is said second print data including identification information identical to the identification information of said first print data in said memory,
when there is said second print data including identification information identical to the identification information of said first print data, display at said display a screen prompting execution of an image formation process of said second print data on said display.

12. The image formation apparatus according to claim 9, wherein said first and second print data include user identification information identifying a user who wishes to print out said image data,
said image formation apparatus further comprising a display,
wherein said controller is configured to
display on said display an authentication screen allowing input of authentication information including said user identification information for allowing said image formation apparatus to be operated,
determine whether an input of said authentication information at said authentication screen is accepted,
execute an authentication process when there is an input of said authentication information,
when said authentication process succeeds, determine whether there is second print data including said user identification information in said authentication information, and
display, on said display, a screen prompting execution of an image formation process of said second print data when there is said second print data including said user identification information.

13. A recording medium recorded with a control program used at an information processing apparatus transmitting image data produced through application software to an image formation apparatus for printing, said information processing apparatus including a computer accepting an input of an instruction to said information processing apparatus via an input device, and controlling a display capable of displaying said image data as an image, and a transmitter transmitting data to said image formation apparatus,
said control program causing said computer to execute a process including the steps of:
determining whether an input of a setting execution instruction of test printing at a setting screen of said image data displayed on said display is accepted, based on an input through said input device,
displaying, on said display, a setting screen directed to finalized printing differing from said test printing when an input of a setting execution instruction of said test printing at the setting screen is accepted,
determining whether an input of a setting execution instruction at said setting screen directed to finalized printing is accepted, based on an input through said input device,
generating a first print job directed to executing test printing of said image data when an input of a setting execution instruction at said setting screen directed to finalized printing is accepted, said first print job including first print data that is a version of said image data converted based on an input of a setting execution instruction of said test printing,
transmitting said generated first print job to said image formation apparatus via said transmitter,
after said first print job is transmitted, generating a second print job directed to executing finalized printing of said image data, said second print job including second print data that is a version of said image data converted based on an input of a setting execution instruction of said finalized printing, and
transmitting said generated second print data to said image formation apparatus via said transmitter.

14. The recording medium according to claim 13, wherein said control program causes said computer to execute a process further including the step of issuing identification information corresponding to said image data when an input of a setting execution instruction of said test printing at said setting screen is accepted,
wherein said step of generating a first print job includes the step of generating said first print job including said first print data and said identification information.

15. The recording medium according to claim 14, wherein said step of generating a second print job includes the step of generating said second print job including said second print data and said identification information.

16. The recording medium according to claim 13, wherein said control program causes said computer to execute a process further including the step of accepting an input of specified page data in said test printing of said image data constituted of a plurality of page data on said setting screen.

17. The recording medium according to claim 13, wherein said computer is further capable of controlling a memory,
said control program causing said computer to execute a process including the steps of
determining whether an input of a modifying instruction of setting contents at said setting screen directed to finalized printing is accepted,
when an input of a modifying instruction at said setting screen directed to finalized printing is accepted, updating and displaying on said display said setting screen directed to finalized printing,
determining whether an input of an instruction to store setting information indicating setting contents at said setting screen directed to finalized printing is accepted, and
when an input of an instruction to store at said setting screen directed to finalized printing is accepted, storing said setting information that can be used for the setting contents at said setting screen directed to finalized printing in said memory.

18. The recording medium according to claim 17, wherein said control program causes said computer to execute a process further including the steps of
comparing setting information indicating setting contents at the setting screen directed to finalized printing with said setting information stored in said memory, based on an input of a setting execution instruction of said finalized printing, and
displaying a confirmation screen of the setting contents on said display when the setting information differ from each other based on the comparison.

19. The recording medium according to claim 17, wherein said control program causes said computer to execute a process further including the steps of
storing, in said memory, setting information indicating setting contents at said setting screen directed to finalized printing associated with identification information identifying said image data, when an input of an instruction to store at said setting screen directed to finalized printing is accepted, and
storing, in said memory, another setting information associated with said identification information according to update of setting contents at said setting screen directed to finalized printing, when an input of an instruction to store at the setting screen directed to finalized printing is accepted a plurality of times.

20. The recording medium according to claim 19, wherein said control program causes the said computer to execute a process including the steps of
determining whether an input of an instruction to read out setting information stored in said memory, appearing at said setting screen directed to finalized printing, is accepted, and
when an input of an instruction to read out, appearing at said setting screen directed to finalized printing, is accepted, displaying on said display a select screen allowing selection of one of a plurality of setting information associated with said identification information stored in said memory.
